(19) United States
(12) Patent Application Publication
(10) Pub. No.: US 2014/0358625 A1
(43) Pub. Date: Dec. 4, 2014

(54) Operating Support System, Operating Support Method and Operating Support Program

(71) Applicants: Yuki Shimizu, Tokyo (JP); Masayuki Hariya, Tokyo (JP)

(72) Inventors: Yuki Shimizu, Tokyo (JP); Masayuki Hariya, Tokyo (JP)

(73) Assignee: Hitachi, Ltd., Chiyoda-ku, Tokyo (JP)

(21) Appl. No.: 14/370,668

(22) PCT Filed: Jan. 11, 2012
(86) PCT No.: PCT/JP2012/050331

§ 371 Date: Jul. 3, 2014

(51) Int. Cl. G06Q 10/06

(52) U.S. Cl. CPC G06Q 10/0633
USPC 705/7.27

(57) ABSTRACT

An operating support system includes a control unit having: accepting the specifications required for a new case; searching a second database based on the accepted specifications; obtaining past cases similar to the extent that the specifications meet predetermined standards; extracting a record of the obtained case from a first database; determining the coefficient by which the presence/absence value is multiplied as the side effect degree for the extracted record; calculating the optimized side effect degree for each task of the obtained record, by calculating the sum of values obtained by multiplying the presence/absence value by the side effect degree for the tasks, and by calculating the difference between the calculated sum and the evaluation value; and comparing the magnitude relationship between the calculated side effect degree and a predetermined threshold to output the task corresponding to the side effect degree, as the task that is omittable in the new case.

### TECHNICAL FIELD

The present invention relates to an operating support system, operating support method and operating support program.

### BACKGROUND ART

Generally in designs such as plants and products, there is created a “standard operating process”, which is a model chart that shows which design operation is performed in what order, or what hierarchal relationship each design operation has with each other. Then, before entering the actual design operation or when a design change and the like occurs after entering the actual design operation, the user as the designer performs activities such as changing, replacing, and deleting each “task” configuring the “standard operating process” to create (customize) a unique operating process that meets the specifications required for the particular case.

In Patent Literature 1, an operating support system extracts the difference between the required specifications and the model. Then, the operating support system extracts a task based on the extracted difference, to create a final operating process based on the extracted task.

In Patent Literature 2, an operating support system prepares a “standard operating process” in advance, so that the content of changes made to the “standard operating process” by each user is shared with all users.

### CITATION LIST

### Patent Literature

Patent Literature 1: Japanese Unexamined Patent Application Publication No. 2009-104562 (Paragraph 0007)
Patent Literature 2: Japanese Unexamined Patent Application Publication No. 2005-108142 (Paragraph 0006)

### SUMMARY OF INVENTION

### Technical Problem

The system described in Patent Literature 1 switches tasks based on a rule determined in advance. However, the switching determination belongs to a specific person and is not made into a rule. For this reason, it is difficult to present the optimal operating process for each case to the user.

The operating support system described in Patent Literature 2 is based on one standard operating process. Thus, when the operating process is customized according to the required specifications, or in the case of a design change, it is necessary to review all of the individual tasks configuring the standard operating process. As a result, the user is prompted to review tasks that are not affected by the required specifications or design change, in which a review may be omitted, requiring a lot of time to complete the customized operating process.

Thus, an object of the present invention is to facilitate activities such as identifying the task that can be omitted, by presenting the side effect degree when the specific task of the standard operating process is omitted.

### Solution to Problem

An operating support system according to the present invention is an operating support system for calculating the influence of each of multiple tasks configuring an operating process on a case to be performed according to the operating process. The operating support system includes a storage unit storing a first database for storing a task, a presence or absence value indicating whether the task is omitted in the case performed, and an evaluation value which is a value indicating the subsequent evaluation of the past case in association with the past case, as well as a second database for storing the specifications required for a past case in association with the past case. Further, the operating support system includes a control unit for accepting the specifications required for a new case, searching the second database based on the accepted specifications, obtaining past cases which are to the extent that the specifications meet predetermined standards, extracting the record of the obtained case from the first database, determining the coefficient by which the presence/absence value is multiplied as the side effect degree with respect to the extracted record, calculating the sum of values obtained by multiplying the presence/absence value by the side effect degree for each task of the extracted record, calculating the optimized side effect degree for each task with respect to the obtained case by calculating the difference between the calculated sum and the evaluation value, comparing the magnitude relationship between the calculated side effect degree and a predetermined threshold, and outputting the task corresponding to the side effect degree, which is identified based on the comparison, as the task that can be omitted in the new case.

Other means will be described in the Description of Embodiments.

### Advantageous Effects of Invention

According to the present invention, it is possible to facilitate activities such as identifying the task that can be omitted, by presenting the side effect degree when the specific task of the standard operating process is omitted.

### BRIEF DESCRIPTION OF DRAWINGS

FIG. 1 is an example of a standard operating process display screen according to first and second embodiments;

FIG. 2 is a block diagram of a design operating support system according to the first embodiment;

FIG. 3 is a view of an example of a reason database according to the first embodiment;

FIG. 4 is a view of an example of a required specification database according to the first embodiment;

FIG. 5(a) shows an example of a case final result database according to the first and second embodiments, and FIG. 5(b) shows an example of a side effect degree database according to the first and second embodiments;

FIG. 6 is a flow chart of a reason registration process procedure according to the first embodiment;

FIG. 7 is a flow chart of a case final result input process procedure according to the first embodiment;

FIG. 8 is a flow chart of a required specification registration process procedure according to the first embodiment;

FIG. 9 is a flow chart of a task omission guidance process procedure according to the first embodiment;

FIG. 10 is an example of a reason registration screen according to the first embodiment;

FIG. 11 is an example of a case final result input screen according to the first and second embodiments;

FIG. 12 is an example of a required specification registration screen according to the first embodiment;

FIG. 13 is an example of a task review necessity determination/reason display screen according to the first embodiment;

FIG. 14 is an example of a standard operating process display screen according to the first and second embodiments;

FIG. 15 is an example of a standard operating process display screen according to the first and second embodiments;

FIG. 16 is a block diagram of a design operating support system according to the second embodiment;

FIG. 17 is a view of an example of a review reason database according to the second embodiment;

FIG. 18 is a view of an example of a specification change database according to the second embodiment;

FIG. 19 is a flow chart of a review reason registration process procedure according to the second embodiment;

FIG. 20 is a flow chart of a case final result input process procedure according to the second embodiment;

FIG. 21 is a flow chart of a specification change registration process procedure according to the second embodiment;

FIG. 22 is a flow chart of a task review guidance process procedure according to the second embodiment;

FIG. 23 is an example of a review reason registration screen according to the second embodiment;

FIG. 24 is an example of a specification change registration screen according to the second embodiment; and

FIG. 25 is an example of a review task/reason display screen according to the second embodiment.

### DESCRIPTION OF EMBODIMENTS

Hereinafter, the mode for carrying out the present invention (which is referred to as “the present embodiment”) will be described in detail with reference to the accompanying drawings. The present embodiment includes first and second embodiments. An operating support system in the claims is not limited to design operation, and can be applied to overall operations involved in the operating process. Hereinafter, a design operating support system will be described as an example of the operating support system. The design operating support system shows task candidates that can be omitted in the first embodiment, and shows task candidates to be reviewed in the second embodiment (details below). The first embodiment will be first described in detail and then the second embodiment will be described as focusing on the difference from the first embodiment.

### First Embodiment

### (Terms)

A case is a unit of operation to be ordered and evaluated.

A task is a unit configuring a case. In general, the task is hierarchized and there are upper level tasks and lower level tasks. The user can omit a part of the case (or can omit a part of the task) by the task as a unit. Then, the side effect degree (details below) is calculated for each task.

An operating process is data showing one or multiple tasks configuring a case, together with the hierarchical relationship of the tasks as well as the order in which the tasks are performed. In general, the operating process has a form similar to a flow chart and can be displayed on an output device and the like.

A standard operating process is an operating process used as a model. For example, when the user performs cases similar to each other, it is possible to easily create a secondary customized operating process based on one standard operating process, by changing, omitting, and the like, a task which is a part of the standard operating process.

A reason is a reason that justifies omitting a review of a certain task, namely, omitting a certain task from the operating process.

A side effect degree is an index indicating, when omitting a review of a certain task, that how much the omission has an effect on the success or failure of the case.

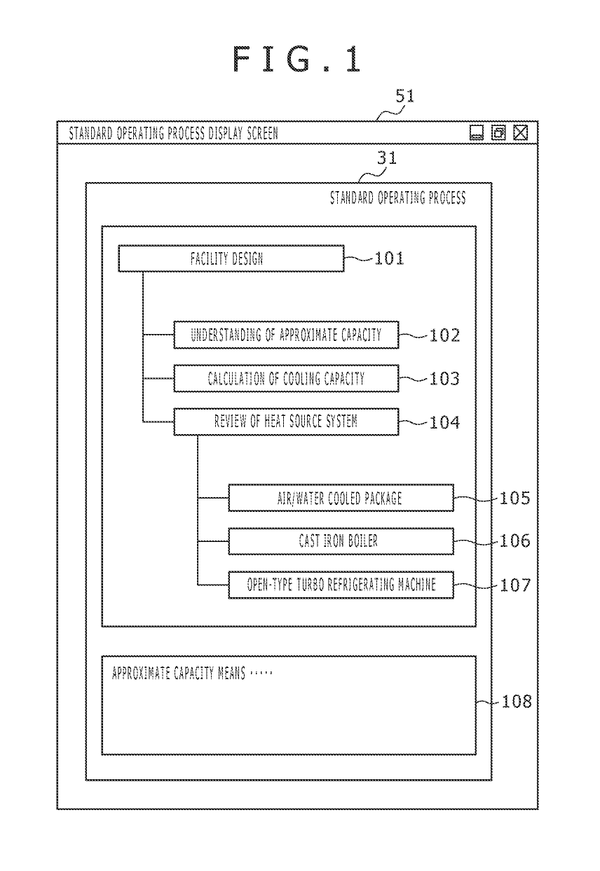

When referring to FIG. 1, a standard operating process 31 is displayed in a standard operating process display screen 51. The standard operating process 31 includes a standard operating process name 101, tasks 102 to 104, and a description field 108. Each of the tasks 102 to 104 has one or multiple (lower level) tasks. Here, only lower level tasks 105 to 107 of the (upper level) task 104 are shown.

The standard operating process 31 relates to an air conditioning facility design. The standard operating process name of the standard operating process 31 is “facility design”. Further, “understanding of approximate capacity”, “calculation of cooling capacity”, and “review of heat source system” are names of the tasks 102 to 104, respectively. Then, these tasks are performed in the order of “understanding of approximate capacity”, “calculation of cooling capacity”, and “review of heat source system”. Further, “air/water cooled package”, “case iron boiler”, and “open-type turbo refrigerating machine” are names of the tasks 105 to 107, respectively. Then, these tasks are reviewed by the user when performing the task “review of heat source system”, basically in the order of “air/water cooled package”, “cast iron boiler”, and “open-type turbo refrigerating machine”. However, each of the tasks may not be necessarily reviewed and may be omitted.

The description field 108 is for detailed description of each task. For example, when the user places the cursor on the task 102 by using an input device such as a mouse, the specific description of the task of “understanding of approximate capacity” is displayed in the description field 108.

### (Design Operating Support System)

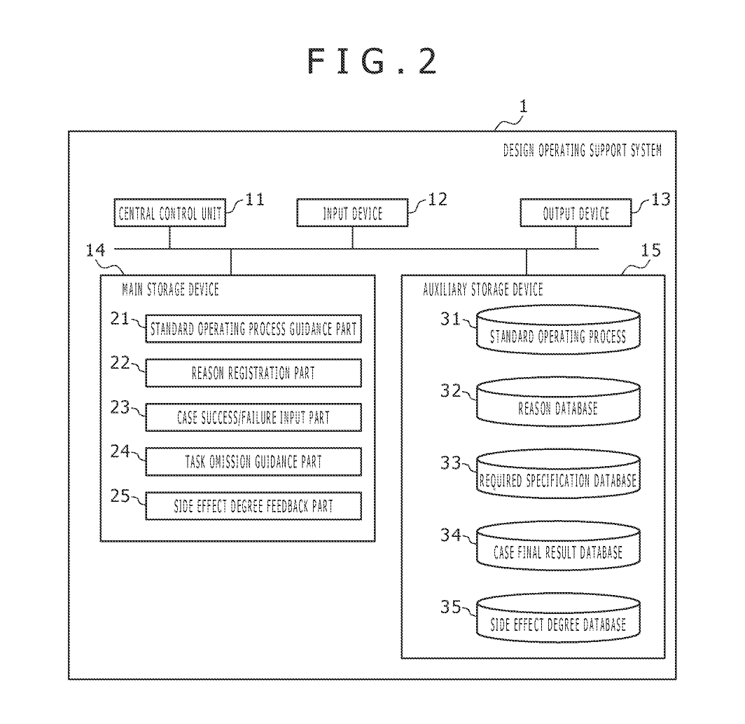

A design operating support system 1 will be described with reference to FIG. 2. The design operating support system 1 is a general computer, including a central control device 11, an input device 12 such as a keyboard and a mouse, an output device 13 such as a display, a main storage device 14, and an auxiliary storage device 15. These components are connected to each other by a bus. The auxiliary storage device 15 stores the standard operating process 31, a reason database 32, a required specification database 33, a case final result database 34, and a side effect degree database 35 (details below). In the main storage device 14, a standard operating process guidance part 21, a reason registration part 22, a case success/failure input part 23, a task omission guidance part 24, and a side effect degree feedback part 25 are programs. Hereinafter, when the subject is described as “something part”, it is assumed that the central control device 11 realizes the function of each program by reading the program from the auxiliary storage device 15 and loading the program to the main storage device 14 (details below).

Note that the “first database” and the “second database” correspond to the “case final result database 34” and the “required specification database 33”, respectively.

### (Reason Database)

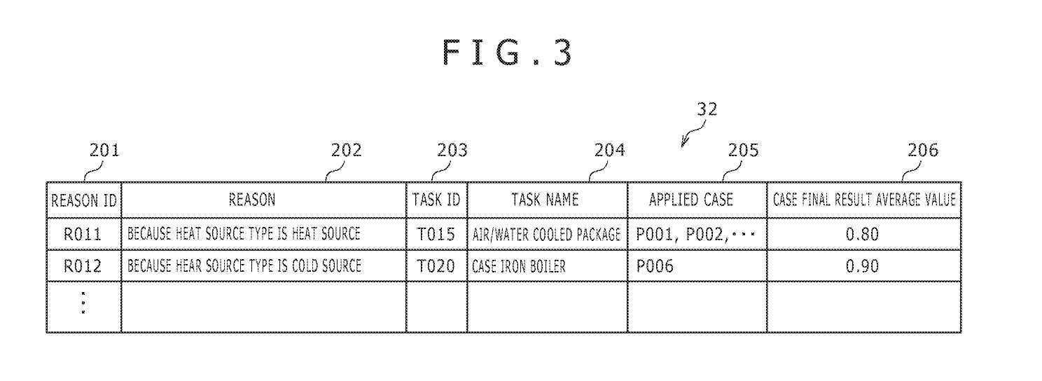

The reason database 32 will be described with reference to FIG. 3. In the reason database 32, the reason is stored in a reason field 202, the task ID is stored in a task ID field 203, the case ID is stored in an applied case field 205, and the case final result average value is stored in a case final result average value field 206, respectively, in association with the reason ID stored in the reason ID field 201.

The reason ID of the reason ID field 201 is the identifier that uniquely identifies the reason.

The reason of the reason field 202 is the description itself of the reason.

The task ID of the task ID field 203 is the identifier that uniquely identifies the task.

The task name of the task name field 204 is the name of the task.

The case ID of the applied case field 205 is the identifier that uniquely identifies the case. Here, one or more cases (applied cases) having a track record of omitting the particular task is identified by applying the particular reason.

The case final result average value of the case final result average value field 206 is the average value of the case final result value (details below) defined for each applied case.

Note that the “evaluation value” corresponds to the “case final result value”.

The record of the reason database 32 exists for the number of combinations of reason IDs and task IDs.

Incidentally, the following facts can be found by referring to the record in the first line in FIG. 3.

(1) By applying the reason “because heat source type is heat source”, there are at least two cases in which a review of the task “air/water cooled package” is omitted. One is the case “P001” and the other is the case “P002”.
(2) By applying the reason “because heat source type is heat source”, the case final result value is defined for each of the cases in which a review of the task “air/water cooled package” is omitted. The average value of the case final result values is “0.80”.

### (Required Specification Database)

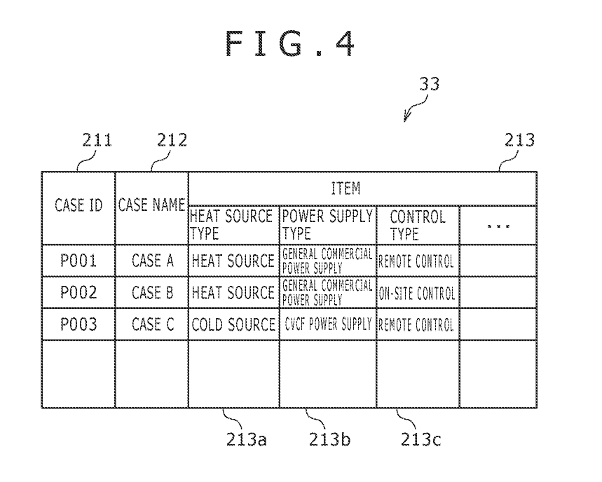

The required specification database 33 will be described with reference to FIG. 4. In the required specification database 33, the case name is stored in a case name field 212, and subfields 213a to 213c with items as headings are stored in an item field 213, respectively, in association with the case ID stored in a case ID field 211.

The case ID of the case ID field 211 is the identifier that uniquely identifies the case.

The case name of the case name field 212 is the name of the case.

The item, which is the heading of the subfields 213a to 213c configuring the item field 213, is the category of the specification required for the case. Here, “heat source type”, “power supply type”, and “control type” are shown as an example of the item. The value of the item stored in the subfields 213a to 213c is the specification itself required for each item.

The record of the required specification database 33 exits for the number of case IDs.

Incidentally, the following facts can be found by referring to the record in the first line in FIG. 4.

(1) The name of the case with the case ID “P001” is “case A”.
(2) There are three requirements for the specification of the particular case. More specifically, it is required that “heat source type” must be “heat source”, “power supply type” must be “general commercial power supply”, and “control type” must be “remote control”.

### (Case Final Result Database)

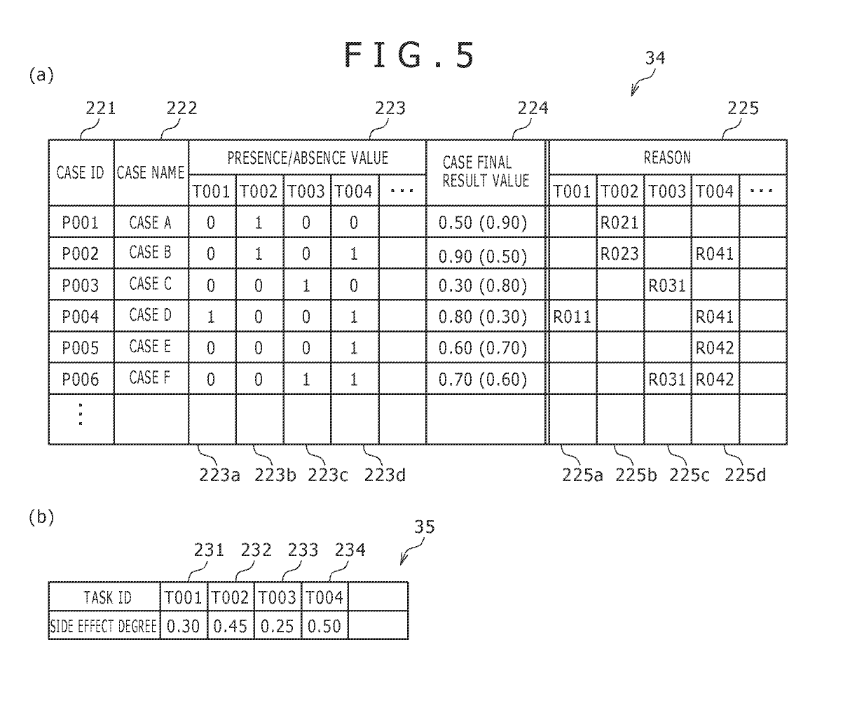

The case final result database 34 will be described with reference to FIG. 5(a). In the case final result database 34, the case name is stored in a case name field 222, subfields 223a to 223d with task IDs as headings are stored in a presence/absence value field 223, the case final result value is stored in a case final result value field 224, and subfields 225a to 225d with task IDs as headings are stored in a reason field 225, respectively, in association with the case ID stored in the case ID field 221.

The case ID of the case ID field 221 is the same as the case ID in FIG. 4.

The case name of the case name field 222 is the same as the case name in FIG. 4.

The task ID, which is the heading of the subfields 223a to 223d configuring the presence/absence value field 223, is the same as the task ID in FIG. 3. The value stored in the subfields 223a to 223d is either “0” or “1”. A “0” indicates that the task identified by the task ID has been reviewed. A “1” indicates that the task identified by the task ID has not been reviewed and omitted. Note that “1” and “0” are hereinafter also referred to as “presence/absence value”.

The case final result value of the case final result value field 224 is the value defined for each case, by the equation of “defective work cost of certain case/order amount of the case”/“maximum value of the values of all cases (defective work cost/order amount)” (details below). The greater the case final result value the poorer the results as the case.

Note that a case final result value with parentheses and a case final result value without parentheses are shown side by side in the case final result field 224 in FIG. 5(a). The case final result value with parentheses is exclusively for the description of the second embodiment described below, and is ignored here.

The task ID, which is the heading of the subfields 225a to 225d configuring the reason field 225, is the same as the task ID in FIG. 3. The value stored in the subfields 225a to 225d is the reason ID itself. Here, the reason ID identifies the reason applied when the task is omitted without review. Note that the reason ID is stored in the subfield of the reason field 225, with the same task ID in the heading as that in the heading of the subfield in which the presence/absence value is “1” in the presence/absence value field 223. The subfield of the reason field 225 with the same task ID in the heading as that in the subfield in which the presence/absence value is “0” in the presence/absence value field, is left blank.

The record of the case final result database 34 exists for the number of case IDs.

Incidentally, the following facts can be found by referring to the records in the first to sixth lines in FIG. 5(a). Note that the specific numbers of the reason IDs and the like shown in FIG. 5(a) are exclusively selected for the description of FIG. 5(a), and do not correspond to the specific numbers of the reason IDs and the like in FIG. 3.

(1) There are at least six cases that have been completed and evaluated.
(2) At least one task is omitted without review with respect to all of these six cases. In other words, every record has at least one presence/absence value “1” in the presence/absence value field 223.
(3) Of the six cases, the case for which the case final result value is the maximum (with poor results as the case) is “case B”. In the “case B”, two tasks identified by the task IDs “T002” and “T004” are omitted without review. The reason ID of the reason applied when the former task is omitted is “R023”, and the reason ID of the reason applied when the latter task is omitted is “R041”.
(4) In order to minimize the case final result value by omitting one task, “T003” should be omitted. This can be understood from the fact that when comparing the first, third, and fifth lines, the case final result value in the third line in which “T003” is omitted is the minimum.
(5) In order to minimize the case final result value by omitting two tasks, “T003” and “T004” should be omitted. This can be understood from the fact that when comparing the second, fourth, and sixth lines, the case final result value in the sixth line in which “T003” and “T004” are omitted is the minimum.
(6) As a result of omitting two tasks, if the case final result value is smaller than when omitting one task, two tasks are obviously omitted. However, there is no such a fact as long as it refers to FIG. 5(a).

### (Side Effect Degree Database)

The side effect degree database 35 will be described with reference to FIG. 5(b). Now, consideration is given to the learning process using the least-square method as follows.

(1) The presence/absence values of the task IDs “T001”, “T002”, and so on, for a case n (n=A, B, and so on) are defined as Xₙ₁, Xₙ₂, and so on. Xₙ₁, Xₙ₂, and so on are either “0” or “1”.
(2) The coefficient by which Xₙ₁, Xₙ₂, and so on, are multiplied is defined as W₁, W₂, and so on. Note that the suffixes 1, 2, and so on, are derived from the task IDs.
(3) The case final result estimation value (Pₙ) for a case n is defined as follows:

Case final result estimation value (Pₙ)=W₁Xₙ₁+W₂Xₙ₂+ . . .

(4) An appropriate initial value (for example “0.5”) is assigned to each of W₁, W₂, and so on.
(5) Pₙ is calculated for all cases n.
(6) The case final result value (the field 224 in FIG. 5(a)) for a case n is defined as Qₙ. Note that Qₙ is the result value (the value indicating the subsequent evaluation of the case).
(7) (P_{A}−Q_{A})²+(P_{B}−Q_{B})²+ . . . is calculated.
(8) The process from (5) to (7) is repeated by slightly changing the values of W₁, W₂, and so on, by a predetermined method. For example, the values of W₁, W₂, and so on, may be randomly changed in the range of 0 to 1, independently.
(9) The combination of the values of W₁, W₂, and so on, is obtained so that the value of (P_{A}−Q_{A})²+(P_{B}−Q_{B})²+ . . . is the minimum.

The values of W₁, W₂, and so on obtained as described above are referred to as the side effect degree of the task “T001”, the side effect degree of the task “T002”, and so on. In FIG. 5(b), such side effect degrees are stored in association with the task IDs (the fields 231 to 234).

### (Outline of Process Procedures)

The following will describe process procedures. There are four process procedures, including: (1) reason registration process procedure; (2) case final result input process procedure; (3) required specification registration process procedure; and (4) task omission guidance process procedure. In general, these process procedures are performed in the order of (1), (2), (3), and (4). The content of the individual procedures will be described in detail with reference to flow charts and screen examples. First, the outline of the individual procedures will be described. Note that the procedures (1), (2), (3) are generally performed by the system administrator, while the procedure (4) is performed by the system user. In other words, the procedures (1), (2), (3) are performed “prior to” the procedure (4).

(1) The reason registration process procedure is the procedure for registering the reason to be applied when a task included in the standard operating process 31 is omitted in each case that will occur in the future, under the assumption that the standard operating process 31 is completed. In general, the reason registration process procedure is performed at the time when the standard operating process 31 is created.

(2) The case final result input process procedure is the procedure for generating data indicating how the case final result value is as a result of the omission of which task by applying which reason, for the case completed in the past. The case final result input process procedure may be performed at the completion of each case, or may be performed in bulk at a certain time for multiple cases that have been completed by that time.

(3) The required specification registration process procedure is the procedure for registering the specifications of cases completed in the past. The required specification registration process procedure may be performed at the completion of each case, or may be performed in bulk at a certain time for multiple cases that have been completed by that time.

(4) The task omission guidance process procedure is the procedure for determining the task that can be omitted among the tasks of the standard operating process 31, to create an operating process customized for a new case. The task omission guidance process procedure is performed immediately before the new case is performed. Then, in the initial stage of the task omission guidance process procedure, the procedure similar to the (3) required specification registration process procedure is performed. In other words, the specifications required for the new case are input.

### (Reason Registration Process Procedure)

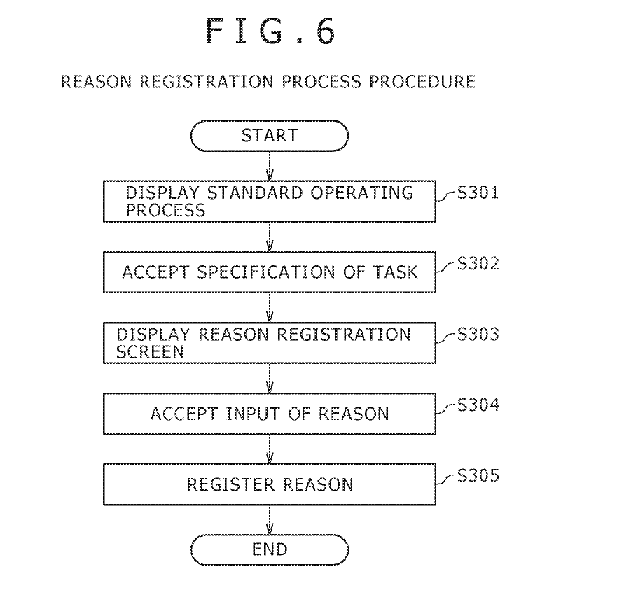

The reason registration process procedure will be described with reference to FIG. 6.

In step S301, the standard operating process guidance part 21 displays the standard operating process 31. More specifically, the standard operating process guidance part 21 first obtains the standard operating process 31 from the auxiliary storage device 15, upon the user inputting a predetermined instruction through the input device 12.

The standard operating process guidance part 21 displays the standard operating process display screen 51 (FIG. 1) on the output device 13. The obtained standard operating process 31 is displayed on the standard operating process display screen 51.

Here, the standard operating process 31 relating to “facility design” is displayed. However, multiple standard operating processes 31 are stored in the auxiliary storage device 15 and the user may select any one of the standard operating processes 31.

In step 302, the reason registration part 22 accepts the specification of a task. More specifically, the reason registration part 22 accepts that the user specifies an arbitrary task to which the reason is to be associated, among the tasks of the displayed standard operating process 31, through the input device 12 such as a mouse. Here, the “air/water cooled package” 105 is specified.

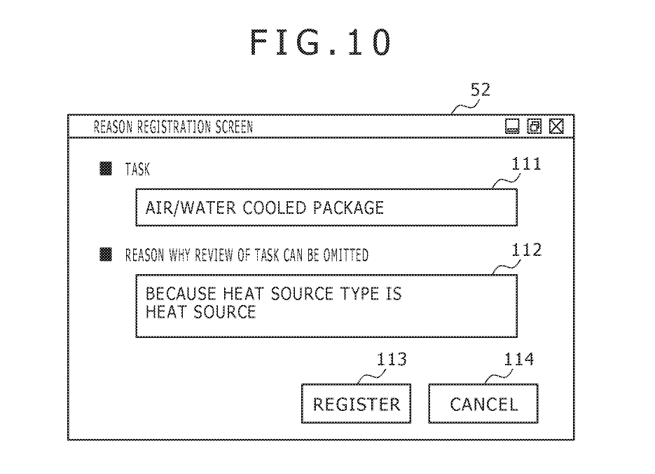

In step S303, the reason registration part 22 displays a reason registration screen 52 (FIG. 10). More specifically, the reason registration part 22 displays the reason registration screen 52 (FIG. 10) on the output device 13. The reason registration part 22 displays the name of the task specified in step S302, in a “task” field 111 of the reason registration screen 52.

In step S304, the reason registration part 22 accepts the input of a reason. More specifically, the reason registration part 22 first accepts that the user inputs a reason in a “reason why review of task can be omitted” field 112 of the reason registration screen 52 through the input device 12 such as the keyboard.

Second, the reason registration part 22 accepts that the user presses a register button 113.

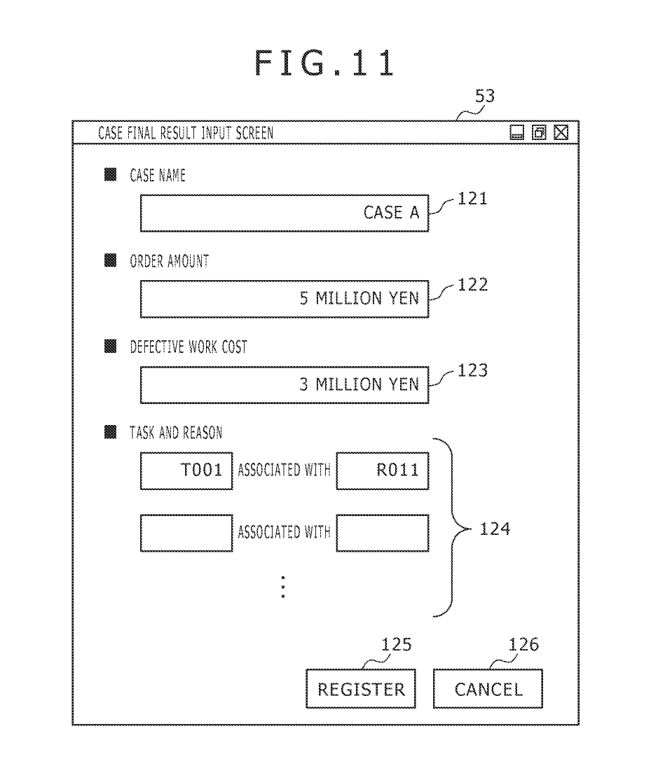

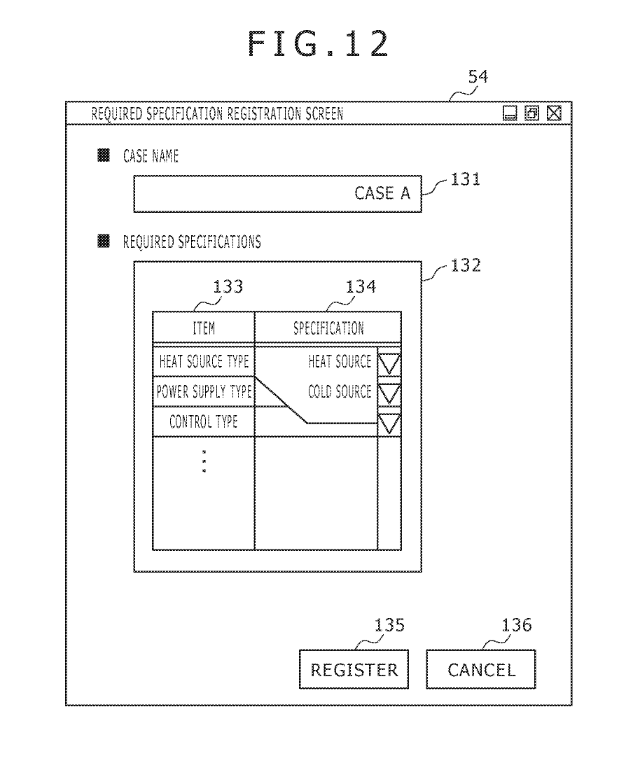

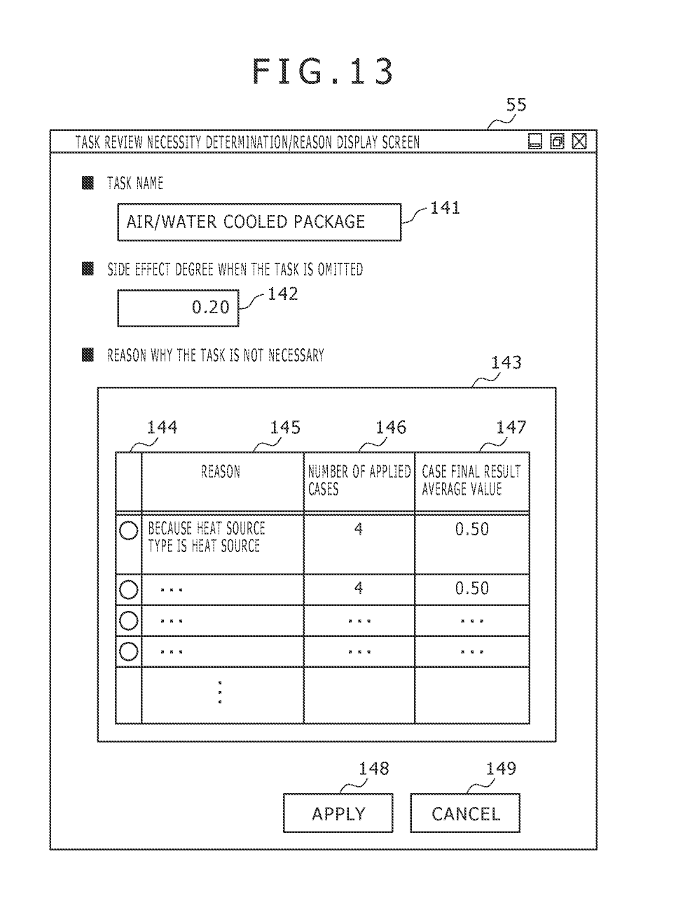

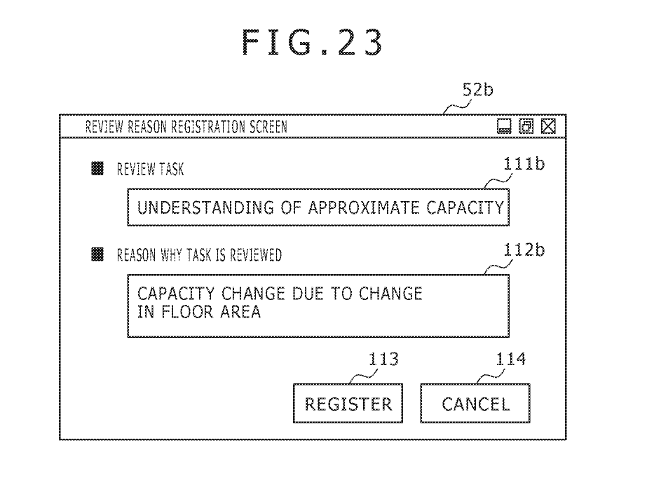

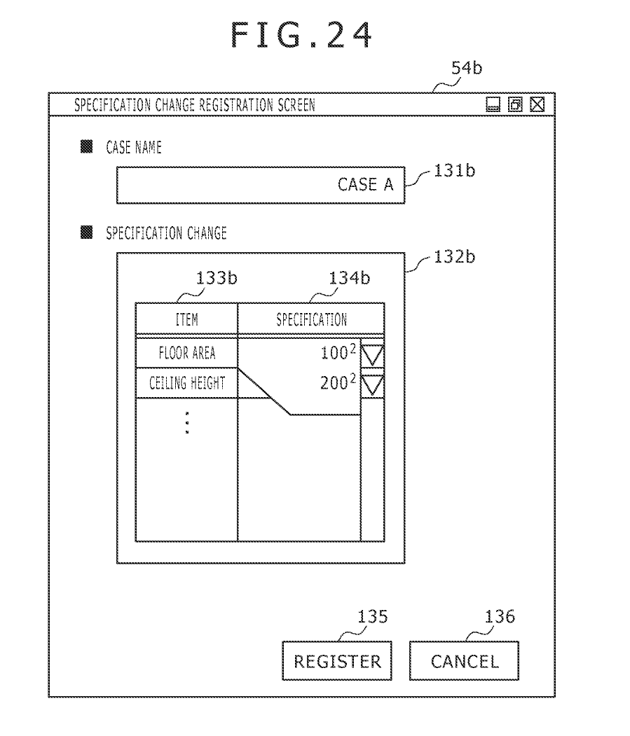

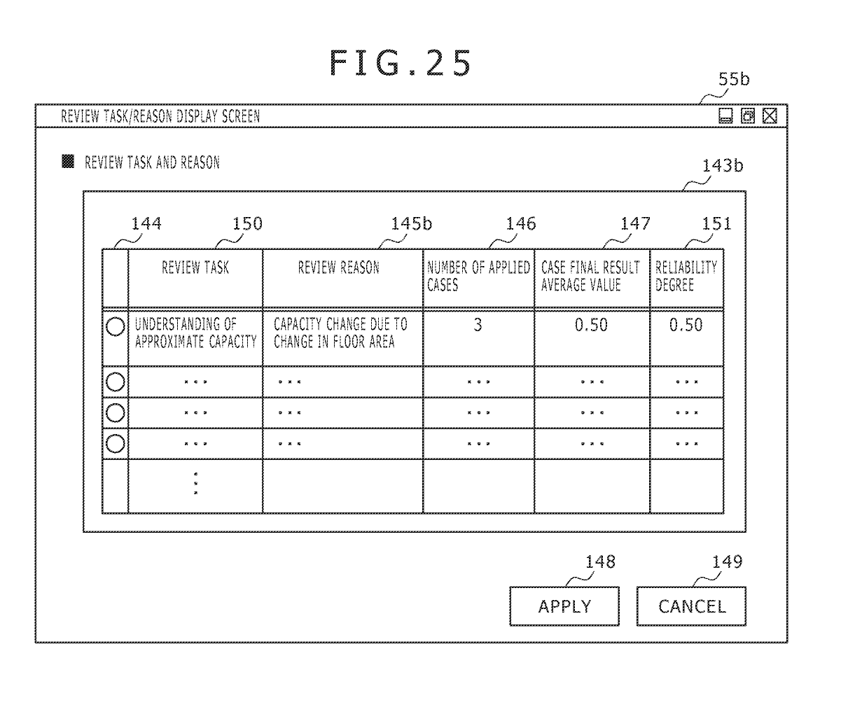

Note that with respect to a cancel button 114 (FIGS. 10 and 23), there are two cases as follows. When the button is pressed after a specific input string and the like is specified by the cursor, the string and the like is deleted, while when the button is pressed without any specification, the screen is deleted. This is the same for a cancel button 126 (FIG. 11), cancel button 136 (FIGS. 12 and 24), and cancel button 149 (FIGS. 13 and 25), which will be described below.

In step S305, the reason registration part 22 registers the reason. More specifically, the reason registration part 22 first generates a new record of the reason database 32 (FIG. 3).

Second, the reason registration part 22 stores the reason accepted in step S304 and the name of the task specified in step S302, respectively, in the reason field 202 and task name field 204 of the new record.

Third, the reason registration part 22 assigns and then stores the reason ID in the reason ID field 201 of the new record, and assigns and then stores the task ID in the task ID field 203 of the new record. The reason registration part 22 may prepare a task ID for identifying each task of the target operating process 31 in advance.

Note that the applied condition field 205 and case final result average value field 206 of the new record are left blank. Then, the reason registration process procedure ends.

### (Case Final Result Input Process Procedure)

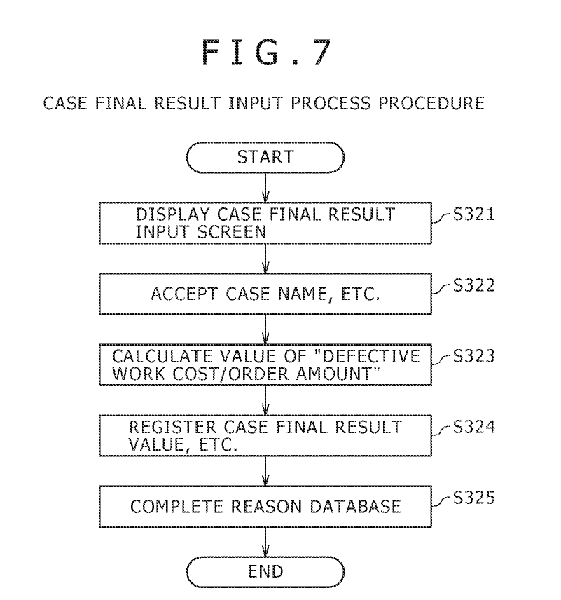

The case final result input process procedure will be described with reference to FIG. 7.

In step S321, the case success/failure input part 23 displays a case final result input screen 53 (FIG. 11). More specifically, the case success/failure input part 23 first displays the case final result input screen 53 on the output device 13, upon the user inputting a predetermined instruction through the input device 12. The timing of the input is when and after the normal case is completed.

In step S322, the case success/failure input part 23 accepts the case name or other information. More specifically, the case success/failure input part 23 first accepts that the user inputs the case name in a case name field 121, the order amount in an order amount field 122, and the defective work cost in a defective work cost field 123. The order amount is the amount paid by the customer, and the like, as the compensation. The defective work cost is the cost required for the production of defective goods (rejected products due to the omission of any task), and the like.

Second, the case success/failure input part 23 accepts that the user inputs the task ID of the task omitted in the particular case as well as the reason ID of the reason applied when the task is omitted, which are associated with each other as a combination for the “task and reason” field 124.

Third, the case success/failure input part 23 accepts that the user presses a register button 125. The case success/failure input part 23 repeats the process of step S322 for all cases completed.

In step S323, the case success/failure input part 23 calculates the value of “defective word cost/order amount”. More specifically, the case success/failure input part 23 first creates a new record of the case final result database 34 (FIG. 5(a)) for the number of combinations accepted in the second part of step S322.

Second, the case success/failure input part 23 calculates the value of “defective work cost/order amount” for each case based on the order amount and defective work cost accepted in the first part of step S322. Then, the case success/failure input part 23 temporarily stores the calculated values in the main storage device 14. The case success/failure input part 23 repeats the process of step S323 for all cases completed.

In step S324, the case success/failure input part 23 registers the case final result value or other information. First, the case success/failure input part 23 calculates the case final result value for each new record of the case final result database 34. As described above, the case final value is defined as “defective work cost of certain case/order amount of the case”/“maximum value of values (defective work cost/order amount) of all cases”. The “values (defective work cost/order amount) of all cases” are obtained by referring to the values temporarily stored in the second part of step S323.

Second, the case success/failure input part 23 stores the case name accepted in the first part of step S322 into the case name field 222 of the new record, and stores the case ID of the particular case in the case ID field 221. Then, the case success/failure input part 23 stores the case final result value calculated in the first part of step S324 into the case final result value field 224.

Third, the case success/failure part 23 stores the reason ID accepted in the second part of step S322 into the subfield of the reason field 225 with the reason ID accepted in the second part of step S322 as the heading. Then, the case success/failure part 23 stores the presence/absence value “1” in the subfield of the presence/absence value field 223 with the task ID accepted in the second part of step S322 as the heading, and stores the presence/absence value “0” in the other subfields of the presence/absence value field 223.

In step S325, the case success/failure input part 23 completes the reason database 32 (FIG. 3). More specifically, the case success/failure input part 23 first obtains any one of the records of the reason database 32. The applied case field 205 and case final result average value field 206 of the obtained record are blank. The obtained record is hereinafter also referred to as the “target record”.

Second, the case success/failure input part 23 searches the reason field 225 of the case final result database 34 (FIG. 5(a)) with the reason ID and task ID of the target record as the search key, to obtain the case ID and case final result value of the matching record. In general, there are multiple matching records. Then, the case success/failure input part 23 calculates the average value of the obtained case final result values.

Third, the case success/failure input part 23 stores the calculated average value in the case final result average value field 206 of the target record, and stores all obtained case IDs in the applied case field 205 of the target record.

Note that the process of step S325 is repeated for all target records that have not been processed. Then, the case final result input process procedure ends.

### (Required Specification Registration Process Procedure)

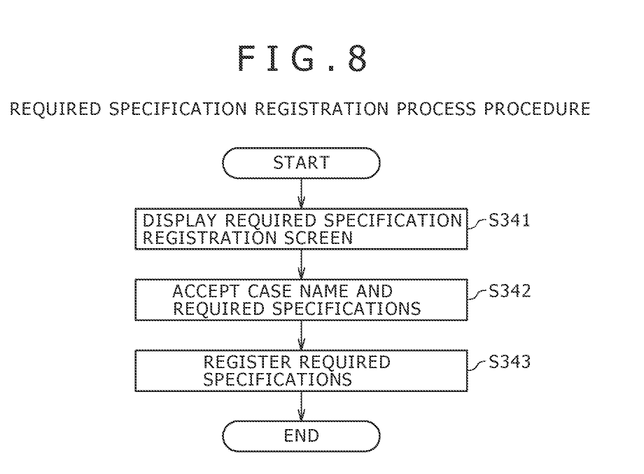

The required specification registration process procedure will be described with reference to FIG. 8.

In step S341, the standard operating process guidance part 21 displays a required specification registration screen 54 (FIG. 12). More specifically, the standard operating process guidance part 21 displays the required specification registration screen 54 on the output device 13, upon the user inputting a predetermined instruction through the input device 12.

In step S342, the standard operating process guidance part 21 accepts the case name and the required specifications. More specifically, the standard operating process guidance part 21 first accepts that the user inputs the case name in a case name field 131 of the required specification registration screen 54.

Second, the standard operating process guidance part 21 accepts that the user associates the item and the specification with each other and inputs in an item field 133 and specification field 134 of the required specification field 132, respectively. With respect to the specification, the standard operating process guidance part 21 may display specification candidates prepared in advance for each item (In FIG. 12, “heat source” and “cold source” are displayed as candidates) to accept that the user selects one of the candidates.

Third, the standard operating process guidance part 21 accepts that the user presses a register button 135.

In step S343, the standard operating process guidance part 21 registers the required specifications. More specifically, the standard operating process guidance part 21 first generates a new record of the required specification database 33 (FIG. 4).

Second, the standard operating process guidance part 21 stores the case name accepted in the first part of step S342. Then, the standard operating process guidance part 21 assigns and then stores the case ID in the case ID field 211 of the new record.

Third, the standard operating process guidance part 21 stores the specification accepted in the second part of step S342 into the subfield with the item corresponding to the specification as the heading in the item field 213 of the new record. Note that if there is no item corresponding to the specification accepted in the second part of step S342, the standard operating process guidance part 21 creates a new subfield with the item as the heading.

Note that the process of steps S342 and S343 is repeated for all past cases. Then, the required specification registration process procedure ends.

### (Task Omission Guidance Process Procedure)

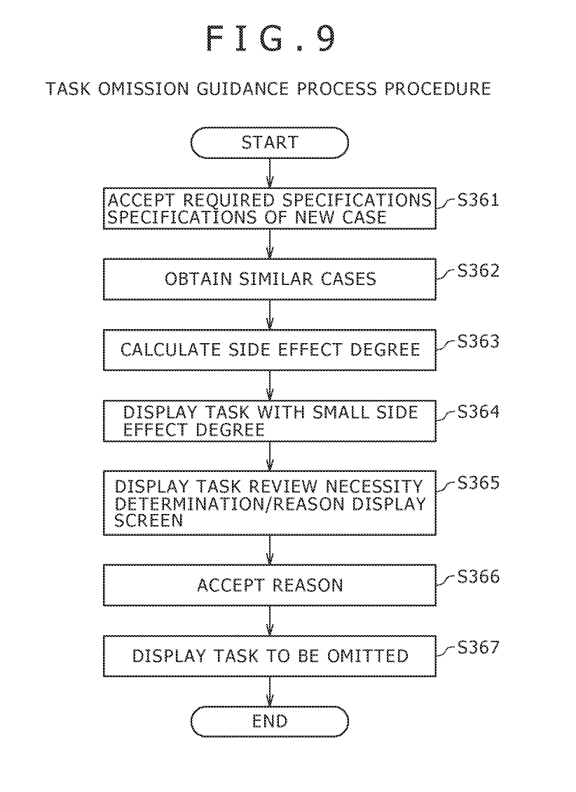

The task omission guidance process procedure will be described with reference to FIG. 9.

In step S361, the side effect degree feedback part 25 accepts the required specifications of the new case. More specifically, the side effect degree feedback part 25 first displays the required specification registration screen 54 (FIG. 12) on the output device 13.

Second, the side effect degree feedback part 25 accepts that the user inputs the case name of the new case in the case name field 131 of the required specification registration screen 54 as well as combinations of items and specifications in the item field 133 and specification field 134 of the required specification field 132, and that the user presses the register button 135. The new case is the case that is not registered in the case final result database 34 (FIG. 5(a)), for which the user considers omitting any task in the future before performing the particular case.

In step S362, the side effect degree feedback part 25 obtains similar cases. More specifically, the side effect degree feedback part 25 first searches the required specification database 33 (FIG. 4) with the combinations of items and specifications accepted on the second part of step S361 as the search key. Then, the side effect degree feedback part 25 obtains the case IDs of all matching records. At this time, the side effect degree feedback part 25 may determine “matching” if the record matches all the combinations used as the search key. However, the side effect degree feedback part 25 may also determine “matching” if the record matches a predetermined number of combinations of all the combinations used as the search key, or if the record matches the number of combinations obtained by multiplying the number of all the combinations used as the search key by a predetermined ratio. For example, it is assumed that the combinations of items and specifications accepted in the second part of step S361 are (heat source type, heat source), (power supply type, general commercial power supply), and (control type, remote control), and that the side effect degree feedback part 25 searches the required specification database 33 with the three combinations as the search key. At this time, not only the record in the first line (exactly matching three combinations) but also the record in the second record (matching two combinations) is determined to be “matching”.

Second, the side effect degree feedback part 25 creates a copy of the case final result database 34 (FIG. 5(a)). Then, the side effect degree feedback part 25 searches the created copy with the case IDs obtained in the first part of step S362 as the search key, to keep the matching records and delete other records. The records kept in this stage are hereinafter also referred to as the “similar records”.

In step S363, the side effect degree feedback part 25 calculates the side effect degree. More specifically, the side effect degree feedback part 25 performs the learning process for the case of all similar records, to obtain (calculate) combinations of the values of W₁, W₂, and so on. Then, the side effect degree feedback part 25 stores the obtained values of W₁, W₂, and so on, as the side effect degree database 35 (FIG. 5(b)).

In step S364, the task omission guidance part 24 displays a task with a small side effect degree. More specifically, the task omission guidance part 24 first identifies the side effect degree smaller than a predetermined threshold, among the side effect degrees (W₁, W₂, and so on) obtained in step S363. Then, the task omission guidance part 24 obtains the task ID corresponding to the side effect degree. Here, there is only one side effect degree smaller than the predetermined threshold and the value is “0.20”.

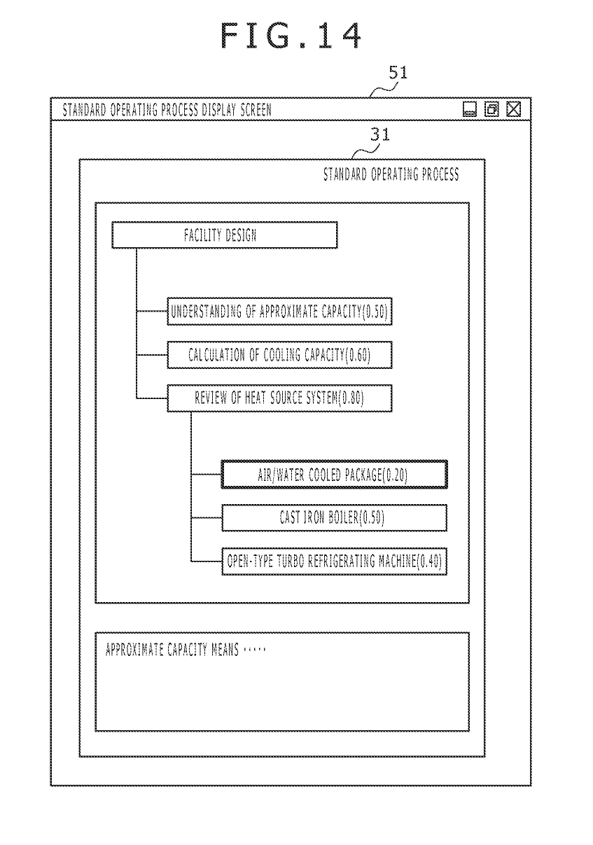

Second, the task omission guidance part 24 displays the standard operating process 31 on the output device 13 (FIG. 14), displays the side effect degree associated with the task, and highlights the side effect degree “0.20” and the task name.

In step S365, the task omission guidance part 24 displays a task review necessity determination/reason display screen 55 (FIG. 13). More specifically, the task omission guidance part 24 first displays the task review necessity determination/reason display screen 55 on the output device 13. Then, the task omission guidance part 24 displays the name of the task identified by the task ID obtained in the first part of step S364. Then, the task omission guidance part 24 displays the side effect degree identified in the first part of step S364 in a “side effect degree when the task is omitted” field 142.

Second, the task omission guidance part 24 searches the reason database 32 (FIG. 3) with the task ID obtained in the first part of step S364 as the search key, to obtain the reason, the case ID (applied case field 205), and the case final result average value, for all matching records.

Third, the task omission guidance part 24 displays the reason obtained in the second part of step S365, in the reason field 145 of the “reason why the task is not necessary” field 143. Then, the task omission guidance part 24 displays the number of case IDs obtained in the second part of step S365 in an application case number field 146. Then, the task omission guidance part 24 displays the case final result average value obtained in the second part of step S365 in the case final result average value field 147. At this time, the number of records displayed in the “reason why the task is not necessary” field 143 is equal to the number of records that match in the second part of step S365.

In step S366, the task omission guidance part 24 accepts the reason. More specifically, the task omission guidance part 24 first accepts that the user selects any one of the records in the “reason why the task is not necessary” field 143. The task omission guidance part 24 displays a radio box field 144 to accept that the user selects one radio box.

Second, the task omission guidance part 24 accepts that the user presses an apply button 148.

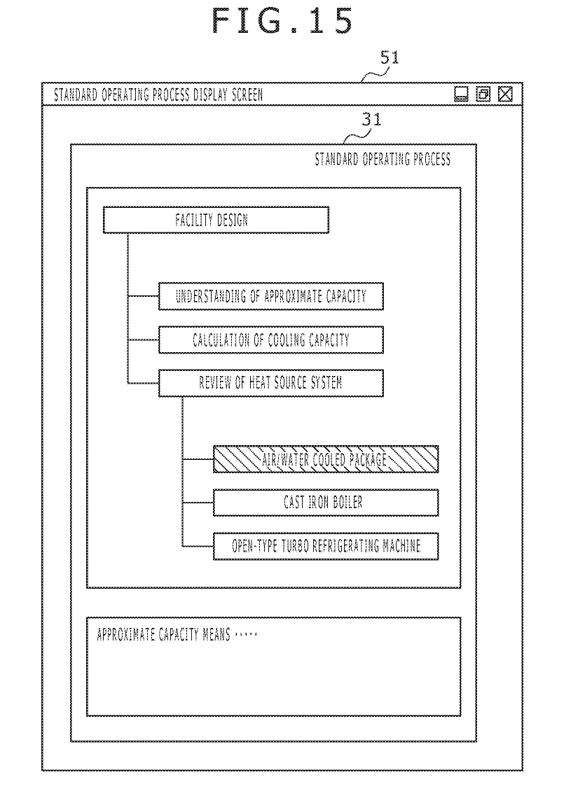

In step S367, the task omission guidance part 24 displays the task to be omitted. More specifically, the task omission guidance part 24 displays the side effect degree and the task name, which are highlighted in the second part of step S364, in another form showing that the omission is determined (for example, gray out, see FIG. 15).

Note that in step S367, the task omission guidance part 24 may create a record of the required specification database 33 (FIG. 4) for the new case, based on the case name, items, and specifications that are accepted in the second part of step S361, as well as a new case ID to be assigned. Further, the task omission guidance part 24 may also create a record of the case final result database 34 (FIG. 5(a)) for the new case, based on the case name accepted in the second part of step S361, the new case ID to be assigned, the task ID obtained in the first part of step S364, and the reason accepted in the first part of step S366. However, the case final result value field 224 is left blank.

Then, the task omission guidance process procedure ends.

### (Effect of the First Embodiment)

The user has performed the task necessity determination based on the experience. In the first embodiment, for example, the task name “air/water cooled package”, the reason “because heat source type is heat source”, and the side effect degree “0.50” are displayed in FIG. 13. When the user views the displayed data, it is possible to easily understand that the particular task can be omitted without a review, by referring to the fact that the required specification of the own new case is “heat source”. Further, the user can quantitatively understand the side effect degree when the particular task is omitted.

### Second Embodiment

In a certain case, the once determined required specifications are often changed. In this case, it is actually difficult to determine the task to which the user gets back to re-examine it. In the second embodiment, the design operating support system 1 displays the situation that the user may face as “review reason”. At the same time, the design operating support system 1 displays the task to be reviewed when this situation occurs as the “review task” (FIG. 25).

In the first embodiment, the design operating support system 1 displays the task with a small side effect degree, as the task that can be omitted. In the second embodiment, the design operating support system 1 displays the task with a high reliability degree (details below) as “review task”.

### (Terms)

A review reason is a reason that justifies a review (re-examination) of a certain task.

A review task is a task to be re-examined by applying the review reason.

A reliability degree is an index that becomes smaller as the side effect degree increases. In general, assuming that the side effect degree is the input value and the reliability degree is the output value, the relationship between the side effect degree and the reliability degree is defined by a function, where the output value becomes smaller as the input value increases. Here, the function is “RELIABILITY DEGREE=1−SIDE EFFECT DEGREE”.

Other terms are the same as the terms in the first embodiment.

### (Design Operating Support System)

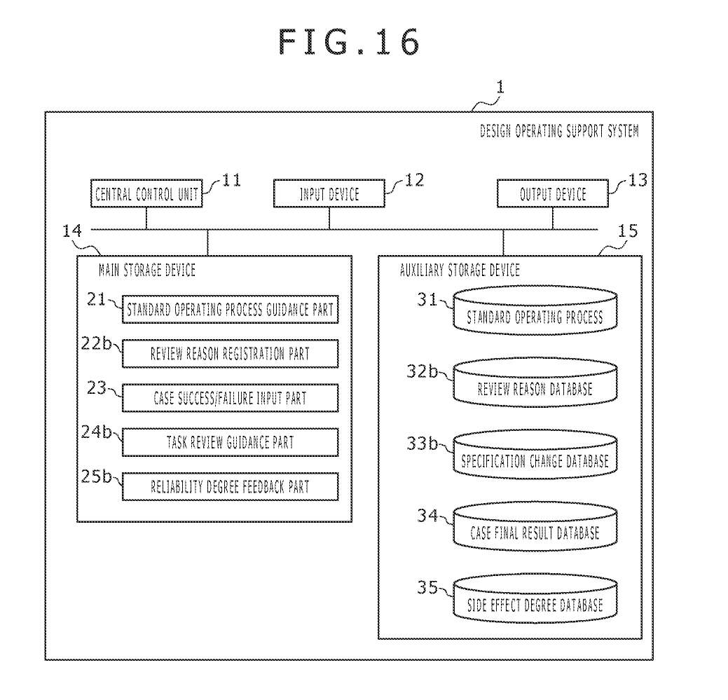

The design operating support system 1 will be described with reference to FIG. 16. The reason registration part 22, the task omission guidance part 24, the side effect degree feedback part 25, the reason database 32, and the required specification database 33 in FIG. 2 are replaced with a review reason registration part 22b, a task review guidance part 24b, a reliability degree feedback part 25b, a review reason database 32b, and a specification change database 33b in FIG. 16, respectively. Other configurations in FIG. 16 are the same as in FIG. 2.

Note that, for example, the review reason database is denoted by reference numeral “32b” relative to the reason database 32, because the two databases correspond to each other and the configurations are also similar to each other. Among similar databases, the same fields are denoted by the same reference numerals and similar fields are denoted by symbols with a “b” affixed to the original symbols (details below).

Further, the “first database” and the “second database” correspond to the “case final result database 34” and the “specification change database 33b”, respectively.

### (Review Reason Database)

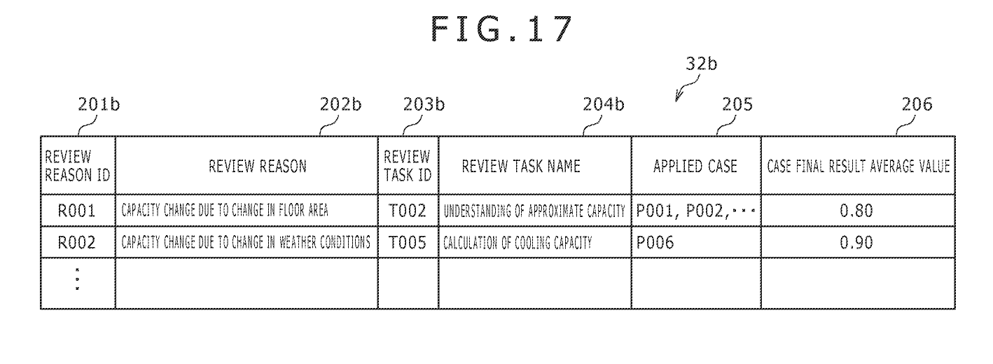

The review reason database 32b will be described with reference to FIG. 17. The reason ID field 201, the reason field 202, the task ID field 203, and the task name field 204 in FIG. 3 are replaced with a review reason ID field 201b, a review reason field 202b, a review task ID field 203b, and a review task name field 204b in FIG. 17, respectively. Other configurations in FIG. 17 are the same as in FIG. 3.

The review reason ID of the review reason ID field 201b is the identifier that uniquely identifies the review reason.

The review reason of the review reason field 202b is the description itself of the review reason.

The review task ID of the review task ID field 203b is the identifier that uniquely identifies the review task.

The review task name of the review task name field 204b is the name of the review task.

The case ID of the applied case field 205 is the identifier that uniquely identifies the case. Here, it is assumed to identify one or multiple cases with the result that the review task has been reviewed by applying the review reason.

The case final result average value of the case final result average value field 206 is the average value of the case final result values (details below) defined for each case applied.

The record of the review reason database 32b exists for the number of combinations of review reason IDs and review task IDs.

### (Specification Change Database)

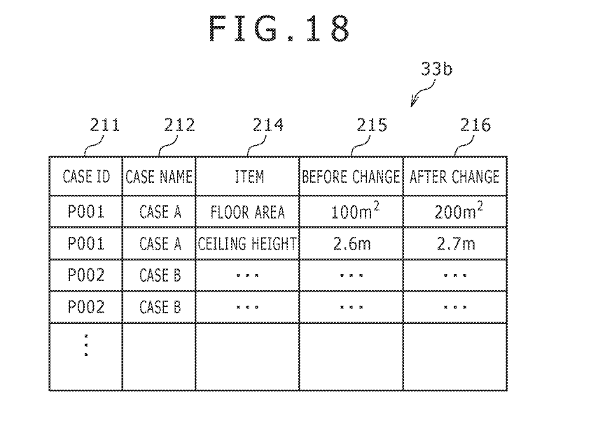

The specification change database 33b will be described with reference to FIG. 18. The specification change database 33b stores the case name in the case name field 212, the item in an item field 214, the value before change for the item in a before-change field 215, and the value after change for the item in an after-change field 216, respectively, in association with the case ID stored in the case ID field 211.

The case ID of the case ID field 211 is the identifier that uniquely identifies the case.

The case name of the case name field 212 is the name of the case.

The item of the item field 214 is the specification the category of the specification required for the case. For example, there are “floor area” and “ceiling height” used as the item.

The value before change for the item in the before-change field 215 is the value of the specification before change of the specification itself required for the item.

The value after change for the item in the after-change field 216 is the value of the specification after change of the specification itself required for the item.

The record of the specification change database 33b exists for the number of combinations of case IDs and items.

### (Case Final Result Database)

In the second embodiment, the same case final result database 34 (FIG. 5(a)) as in the first embodiment is used. However, the meaning of the presence/absence value (field 223) in the second embodiment is different from the meaning of the presence/absence value in the first embodiment. In the second embodiment, the presence/absence value “0” shows that the task identified by the task ID has not been reviewed. The presence/absence value “1” shows that the task identified by the task ID has been reviewed.

Thus, in the second embodiment, for example, the following can be found by referring to the records in the first to sixth lines of FIG. 5(a). Note that case final result values with parentheses and case final result values without parentheses are shown side by side in the case final result value field 224 in FIG. 5(a). The case final result values with parentheses are exclusively for the description of the first embodiment described below, and are ignored here.

(1) There are at least six cases that are completed after the specification change and evaluated.
(2) At least one task is reviewed for all the six cases. In other words, all the records have at least one presence/absence value “1” in the presence/absence value field 223.
(3) Of the six cases, “case A” has the maximum case final result value (with a poor result as the case). In the “case A”, the task of the task ID “T002” is reviewed. The reason ID of the reason applied when the particular task is omitted is “R021”.
(4) In order to minimize the case final result value (to maximize the result as the case) by reviewing one task, the task ID “T004” should be reviewed. This can be understood from the fact that the case final result value is the minimum in the fifth line in which “T004” is reviewed, when comparing the first, third, and fifth lines.
(5) In order to minimize the case final result value by reviewing two tasks, “T001” and “T004” should be omitted. This can be understood from the fact that the case final result value is the minimum in the fourth line in which “T001” and “T004” are reviewed, when comparing the second, fourth, and sixth lines.
(6) As a result of the review of one task, if the case final result value is smaller than when two tasks are viewed, it is obvious that only one task is reviewed. However, there is no such a fact as long as it refers to FIG. 5(a).

Note that for convenience, the same example as the example in the first embodiment is used for the reason ID of the reason field 225 in the second embodiment. For example, the second embodiment is described assuming that “R021” corresponds to “T002” for the record in the first line. Obviously, the reason for the omission of the task and the reason for the review of the task are different. Thus, for example, the review reason identified by “R021” in this embodiment is different from the reason identified by “R021” in the first embodiment.

### (Outline of Process Procedures)

Hereinafter, process procedures will be described. There are four process procedures as follows: (1) review reason registration process procedure; (2) case final result input process procedure; (3) specification change registration process procedure; and (4) task review guidance process procedure. These process procedures are generally performed in the order of (1), (2), (3), and (4). The content of the individual process procedures will be described in detail below with reference to flow charts and screen examples. First, the outline of the individual procedures will be described. Note that the procedures (1), (2), (3) are generally performed by the system administrator and the procedure (4) is performed by the system user. In other words, the procedures (1), (2), (3) are performed “prior to” the procedure (4).

(1) The review reason registration process procedure is the procedure for registering the review reason applied when the task included in the standard operating process 31 is reviewed in each case whose required specification is once set and then changed, under the assumption that the standard operating process 31 is completed. In general, the review reason registration process procedure is performed at the time when the target operating process 31 is created.

(2) The case final result input process procedure is the procedure for generating data showing the change in the side effect degree and the reliability degree as a result of which review task is reviewed by applying which review reason, for each case whose required specification is once set and then changed (hereinafter also referred to as the “case with specification change), among the cases completed in the past. The case final result input process procedure may be performed at the completion of a case with specification change among the individual cases, or may be performed in bulk at a certain time for multiple cases that have been completed by that time.

(3) The specification change registration process procedure is the procedure for registering the specifications before and after change for the case with specification change, among the cases completed in the past. The specification change registration process procedure may be performed at the completion of a case with specification change among the cases, or may be performed in bulk at a certain time for multiple cases that have been completed by that time.

(4) The task review guidance process procedure is the procedure for determining the review task that should be the start of the task to be reviewed, among the tasks of the standard operating process 31, in order to create an operating process that is customized for the case with specification change. The task review guidance process procedure is performed each time the specification of a certain case is changed. Then, in the initial stage of the task review guidance process procedure, the procedure similar to the (3) specification change registration process procedure, is performed. In other words, the specifications before and after change are input for the case with specification change.

### (Review Reason Registration Process Procedure)

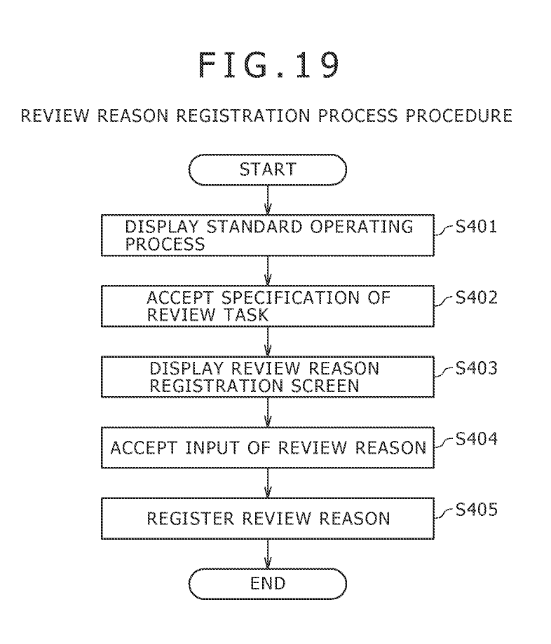

The review reason registration process procedure will be described with reference to FIG. 19.

In step S401, the standard operating process guidance part 21 displays the standard operating process 31. More specifically, the standard operating process guidance part 21 first obtains the standard operating process 31 from the auxiliary storage device 15, upon the user inputting a predetermined instruction through the input device 12.

Second, the standard operating process guidance part 21 displays the standard operating process display screen 51 on the output device 13 (FIG. 1). It is assumed that the obtained standard operating process 31 is displayed in the standard operating process display screen 51.

Here, it is assumed that the standard operating process 31 relating to the “facility design” is displayed. However, multiple standard operating processes 31 are stored in the auxiliary storage device 15 and the user may select any one of the multiple standard operating processes 31.

In step S402, the review reason registration part 22b accepts the specification of the review task. More specifically, the review reason registration part 22b accepts that the user specifies any one of the tasks of the displayed standard operating process 31, to which the review reason should be associated, through the input device 12 such as the mouse. Here, the “understanding of approximate capacity” 102 is specified.

In step S403, the review reason registration part 22b displays a review reason registration screen 52b (FIG. 23). More specifically, the review reason registration part 22b displays the review reason registration screen 52b on the output device 13. It is assumed that the review reason registration part 22b displays the name of the task specified in step S402 in a “review task” field 111b of the review reason registration screen 52b.

In step S404, the review reason registration part 22b accepts the input of the review reason. More specifically, the review reason registration part 22b first accepts that the user inputs the review reason in a “task review reason” field 112b of the review reason registration screen 52b, through the input device 12 such as the keyboard.

Second, the review reason registration part 22b accepts that the user presses the register button 113.

In step 405, the review reason registration part 22b registers the review reason. More specifically, the review reason registration part 22b first generates a new record of the review reason database 32b (FIG. 17).

Second, the review reason registration part 22b stores the review reason accepted in step S404 as well as the name of the task specified in step S402, respectively, in the review reason field 202b and review task name field 204b of the new record.

Third, the review reason registration part 22b assigns and then stores the review reason ID in the review reason ID field 201b of the new record. At the same time, the review reason registration part 22b assigns and then stores the review task ID in the review task ID field 203b of the new record. The review reason registration part 22b may prepare review task IDs that identify the individual tasks of the standard operating process 31 in advance.

Note that the applied condition field 205 and case final result average value field 206 of the new record are left blank. Then, the review reason registration process procedure ends.

### (Case Final Result Input Process Procedure)

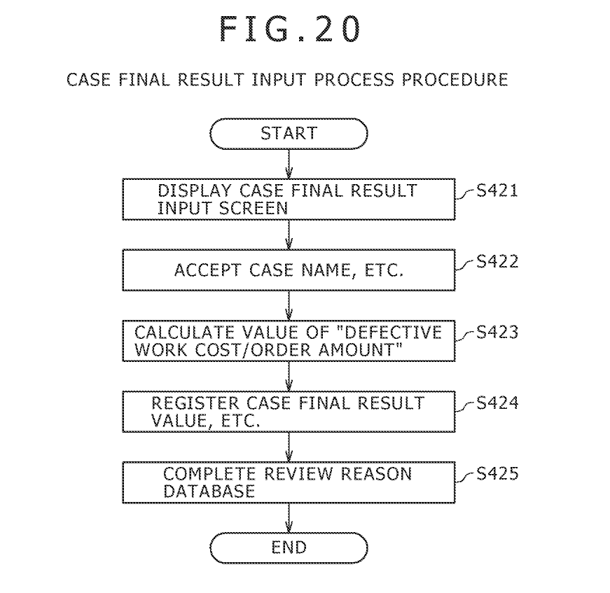

The case final result input process procedure will be described with reference to FIG. 20.

In step S421, the case success/failure input part 23 displays the case final result input screen 53 (FIG. 11). More specifically, the case success/failure input part 23 first displays the case final result input screen 53 on the output device 13, upon the user inputting a predetermined instruction through the input device 12. The timing of the input is when and after the normal case is completed.

In step S422, the case success/failure input part 23 accepts the case name or other information. More specifically, the case success/failure input part 23 first accepts that the user inputs the case name in the case name field 121, the order amount in the order amount field 122, and the defective work cost in the defective work cost field 123. The order amount is the amount paid by the customer and the like as the compensation. The defective work cost is the cost required for the production of defective goods (rejected products due to the omission of any task), and the like.

Second, the case success/failure input part 23 accepts that the user inputs the review task ID of the task reviewed in the particular case, as well as the review reason ID of the review reason applied when the particular task is viewed, which are associated with each other as a pair for the “task and reason” field 124.

Third, the case success/failure input part 23 accepts that the user presses the register button 125. The case success/failure input part 23 repeats the process of step S422 for the case with specification change, among all the cases that have been completed.

In step S423, the case success/failure input part 23 calculates the value of “defective work cost/order amount”. More specifically, the case success/failure input part 23 first generates a new record of the case final result database 34 (FIG. 5(a)) for the number of combinations accepted in the second part of step S422.

Second, the case success/failure input part 23 calculates the value of “defective work cost/order amount” for each case, based on the order amount and defective work cost accepted in the first part of step S422. Then, the case success/failure input part 23 temporarily stores the data in the main storage device 14. The case success/failure input part 23 repeats the process of step S423 for the case with specification change among all the cases that have been completed.

In step S424, the case success/failure input part 23 registers the case final result value or other information. More specifically, the case success/failure input part 23 first calculates the case final result value for each new record of the case final result database 34. As described above, the case final result value is defined as “defective work cost of certain case/order amount of the case”/“maximum value of values (defective work cost/order amount) of all cases”. The “values of (defective work cost/order amount) of all cases” are obtained by referring to the values temporarily stored in the second part of step S423.

Second, the case success/failure input part 23 stores the case name accepted in the first part of step S422 into the case name field 222 of the new record. Further, the case success/failure input part 23 stores the case ID of the particular case into the case ID field 221. Then, the case success/failure input part 23 stores the case final result value calculated in the first part of step S424 into the case final result value field 224.

Third, the case success/failure input part 23 stores the review reason ID accepted in the second part of step S422, into the subfield with the review task ID accepted in the second part of step S422 as the heading in the reason field 225. Then, the case success/failure input part 23 stores the presence/absence value “1” in the subfield with the review task ID accepted in the second part of step S422 as the heading in the presence/absence value field 223, and the presence/absence value “0” in the other subfields of the presence/absence value field 223.

In step S425, the case success/failure input part 23 completes the review reason database 32b (FIG. 17). More specifically, the case success/failure input part 23 first obtains any one of the records of the review reason database 32b. The applied case field 205 and case final result average value field 20 of the obtained record are blank. The obtained record is hereinafter also referred to as the “target record”.

Second, the case success/failure input part 23 searches the reason field 225 of the case final result database 34 (FIG. 5(a)) with the review reason ID and review task ID of the target record as the search key, to obtain the case ID and case final result value of the matching record. In general, multiple records match. Then, the case success/failure input part 23 calculates the average value of the obtained case final result values.

Third, the case success/failure input part 23 stores the calculated average value in the case final result average value field 206 of the target record. Then, the case success/failure input part 23 stores all the obtained case IDs in the applied case field 205 of the target record.

Note that the process of step S425 is repeated for all target records that have not been processed. Then, the case final result input process procedure ends.

### (Specification Change Registration Process Procedure)

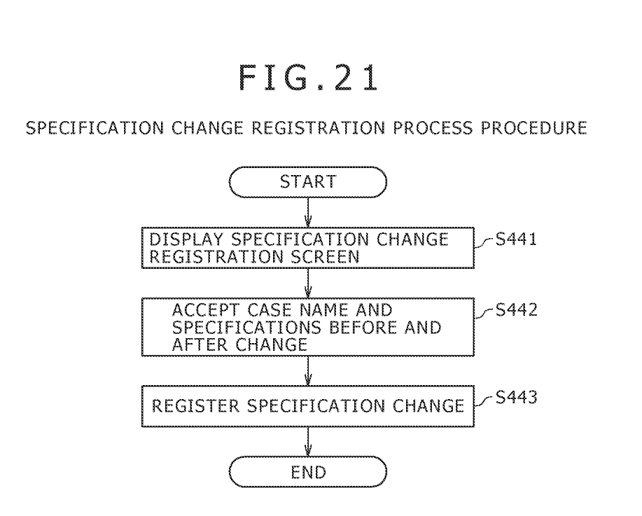

The specification change registration process procedure will be described with reference to FIG. 21.

In step S441, the target operating process guidance part 21 displays a specification change registration screen 54b (FIG. 24). More specifically, the standard operating process guidance part 21 displays the specification change registration screen 54b on the output device 13, upon the user inputting a predetermined instruction through the input device 12.

In step S442, the standard operating process guidance part 21 accepts the case name and the specifications before and after change. More specifically, the standard operating process guidance part 21 first accepts that the user inputs the case name in a case name field 131b of the specification change registration screen 54b.

Second, the standard operating process guidance part 21 accepts that the user associates the item, the specification before change, and the specification after change with each other and inputs in an item field 133b and specification field 134b of the specification change registration screen 54b, respectively. With respect to the specification, the standard operating process guidance part 21 can display specification candidates prepared for each item in advance (in FIG. 24, “100 m²” and “200 m²” are displayed as candidates) to accept that the user selects two of them. The standard operating process guidance part 21 treats the specification first selected by the user as the specification before change, and the specification next selected by the user as the specification after change.

Third, the standard operating process guidance part 21 accepts that the user presses the register button 135.

In step S443, the standard operating process guidance part 21 registers the specification change. More specifically, the standard operating process guidance part 21 first generates a new record of the specification change database 33b (FIG. 18). Note that if there are multiple items accepted in the second part of step S442, the standard operating process guidance part 21 generates a new record for the number of items.

Second, the standard operating process guidance part 21 stores the case name accepted in the first part of step S442 into the case name field 212 of the new record. Then, the standard operating process guidance part 21 assigns and then stores the case ID in the case ID field 211 of the new record.

Third, the case operating process guidance part 21 stores the item, the specification before change, and the specification after change, which are accepted in the second part of step S442, into the item field 214, the before-change field 215, and the after-change field 216 for the new record, respectively.

Note that the process of step S442 and step S443 is repeated for the case with specification change among all past cases.

Then, the specification change registration process procedure ends.

### (Task Review Guidance Process Procedure)

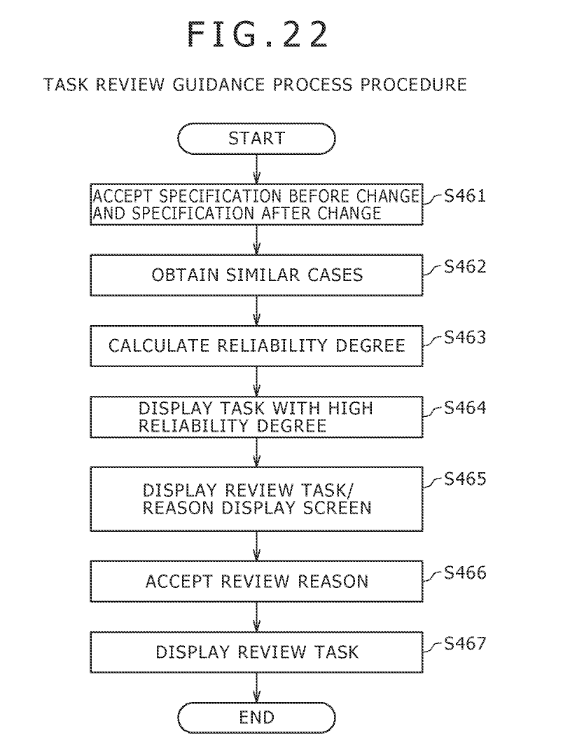

The task review guidance process procedure will be described with reference to FIG. 22.

In step S461, the reliability degree feedback part 25b accepts the specification before change and the specification after change. More specifically, the reliability degree feedback part 25b first displays the specification change registration screen 54b (FIG. 24) on the output device 13.

Second, the reliability degree feedback part 25b accepts that the user inputs the case name of the case with current specification change in the case name field 131b of the specification change registration screen 54b, the item with the change in the item field 133 of the specification change field 132b, and the specification before change and the specification after change in the specification change field 132b. Then, the reliability degree feedback part 25b accepts that the user presses the register button 135. The case with current specification change is the case that is not registered in the case final result database 34 (FIG. 5(a)), for which the user considers a review of any task according to the specification change.

In step S462, the reliability degree feedback part 25b obtains similar cases. More specifically, the reliability degree feedback part 25b first searches the specification change database 33b (FIG. 18) with a combination of the item, the specification before change, and the specification after change that are accepted in the second part of step S461 as the search key, to obtain case IDs of all matching records. At this time, the reliability degree feedback part 25b may determine “matching” if the record exactly matches the item, the specification before change, and the specification after changer, which are included in the combination used as the key. However, it is also possible to define an error range including the value(s) of the specification before change and/or specification after change used as the search key, and determine “matching” if the record matches in this range.

For example, it is assumed that the item, the specification before change, and the specification after change, which are the combination accepted in the second part of step S461, are “floor area”, “100 m²”, and “200 m²”, respectively, and that the error rate of the specification before change and the error rate of the specification after change are “±20%” and “±30%”, respectively. In this case, the reliability degree feedback part 25b searches the specification change database 33b with the item “floor area”, the specification before change “80 m² to 120 m²” and the specification after change “140 m² to 260 m²” as the search key. Then, for example, the record with the item “floor area”, the specification before change “90 m²”, and the specification after change “220 m²” is also determined as the matching record.

Second, the reliability degree feedback part 25b generates a copy of the case final result database 34 (FIG. 5(a)). Then, the reliability degree feedback part 25b searches the generated copy with the case ID obtained in the first part of step S462 as the search key, and keeps the matching records and deletes other ones. The records kept in this stage are hereinafter also referred to as the “records with similar change content”.

In step S463, the reliability degree feedback part 25b calculates the reliability degree. More specifically, the reliability degree feedback part 25b performs the learning process (the same as that in the first embodiment) for all the cases of the records with similar change content, obtains (calculates) a combination of the values of W₁, W₂, and so on, and stores the obtained values of W₁, W₂, and so on, as the side effect degree database 35 (FIG. 5(b)). Then, the reliability degree feedback part 25b stores the values of Z₁=1−W₁, Z₂=1−W₂, and so on, as the reliability degree in the auxiliary storage device 15 in the same form as in FIG. 5(b) (not shown).

In step S464, the task review guidance part 24b displays a task with a high reliability degree. More specifically, the task review guidance part 24b first identifies the reliability degree higher than a predetermined threshold, among the reliability degrees (Z₁, Z₂, and so on) obtained in step S463. Then, the task review guidance part 24b obtains the review task ID corresponding to the reliability degree. Here, there is only one reliability degree higher than the predetermined threshold and the value is “0.75”.

Second, the task review guidance part 24b displays the standard operating process 31 on the output device 13. Further, the task review guidance part 24b displays the reliability degree in association with the review task, and highlights the reliability degree “0.75” and the review task name. In other words, “understanding of approximate capacity (0.75)” is in a highlighted state in FIG. 14.

In step S465, the task review guidance part 24b displays a review task/reason display screen 55b (FIG. 25). More specifically, the task review guidance part 24b first searches the review reason database 32b (FIG. 17) with the review task ID obtained in the first part of step S464 as the search key. Then, the task review guidance part 24b obtains the review reason, the case ID (applied case field 205), the review task name, and the case final result average value for all matching records.

Second, the task review guidance part 24b displays the review task name obtained in the first part of step S465, in the review task field 150 of a “review task and reason” field 143b of the review task/reason display screen 55b, the review reason obtained in the first part of step S465 in the review reason field 145b, the number of case IDs obtained in the first part of step S465 in the application case number field 146, the case final result average value obtained in the first part of step S465 in the case final result average value field 147, and the reliability degree identified in the first part of step S464 in the reliability degree field 151. At this time, the number of records displayed in the “review task and reason” field 143b is equal to the number of records matching in the first part of step S465.

In step S466, the task review guidance part 24b accepts the review reason. More specifically, the task review guidance part 24b first accepts that the user selects any one of the records of the “review task and reason” field 143b. The task review guidance part 24b displays the radio box field 144 so as to accept that the user selects one radio box.

Second, the task review guidance part 24b accepts that the user presses the apply button 148.

In step S467, the task review guidance part 24b displays the review task. More specifically, the task review guidance part 24b displays the review task name highlighted in the second part of step S464 in another form (for example, gray out) showing that the review has been determined. At this time, for example, “understanding of approximate capacity (0.75)” is grayed out. In other words, “understanding of approximate capacity (0.75)” is in a grayed out state in FIG. 15.

Note that in step S467, the task review guidance part 24b may generate a record of the specification change database 33b (FIG. 18) for the case with specification change, based on the case name, item, specification before change, and specification after change accepted in the second part of step S461, as well as the assigned case ID. Further, the task review guidance part 24b may generate a record of the case final result database 34 (FIG. 5(a)) for the case with specification change, based on the case name accepted in the second part of step S461, as well as the review task and review reason of the record selected in the first part of step S466. However, the case final result value field 224 is blank.

Then, the task review guidance process procedure ends.

### (Variation of the Second Embodiment)

In the above step S464, the task review guidance 24b simply displays the task with a high reliability degree. However, it is also possible to narrow the number of tasks (the tasks performed in the past by the user) to display a task with a high reliability degree as the “review task”, among the narrowed tasks.

For example, it is assumed that the auxiliary storage device 15 stores “task hierarchical information” (not shown) that indicates the hierarchical relationship between tasks. It is assumed that the task hierarchical information includes the task ID of one task on the upper stream side than a particular task, as well as one task or multiple tasks on the lower steam side than the particular task, in association with the task ID of the particular task. In other word, the task review guidance part 24b can understand the hierarchical relationship and branch state of the standard operating process 31 (FIG. 1), by referring to the task hierarchical information.

In the first part of step S464, the task review guidance part 24b performs the following process steps:

(1) accepting that the user specifies the currently performed task;
(2) searching the task hierarchical information with the task ID of the accepted task as the search key, to obtain task IDs of all tasks that can be traced back staring from the current task; and
(3) identifying the task with the reliability degree higher than a predetermined threshold as the review task. Here, multiple tasks may be identified. In this case, one task on the lowermost steam side (which requires, in general, little time and effort for review compared to the tasks on the upper stream side) among the multiple tasks, as the review task.

### (Effect of the Second Embodiment)

The user has performed the review determination based on the experience. In the second embodiment, for example, the review task name “understanding of approximate capacity”, the review reason “capacity change due to change in floor area”, and the degree of reliability “0.50” are displayed in FIG. 25. The user views the information and can easily understand that it is beneficial to re-examine the particular review task by referring to the fact that the specification “floor area” is changed in the own case. Further, the user can quantitatively understand the reliability degree when the particular review task is re-examined.

The present invention is not limited to the above exemplary embodiments and various changes and modifications can be made without departing from the scope of the present invention.

### LIST OF REFERENCE SIGNS

1. Design operating support system
11. Central control device (control unit)
12. Input device
13. Output device
14. Main storage device (storage unit)
15. Auxiliary storage device (storage unit)
21. Standard operating process guidance part
22. Reason registration part
22b. Review reason registration part
23. Case success/failure input part
24. Task omission guidance part
24b. Task review guidance part
25. Side effect degree feedback part
25b. Reliability degree feedback part
31. Standard operating process
32. Reason database
32b. Review reason database
33. Required specification database (second database)
33b. Specification change database (second database)
34. Case final result database (first database)
35. Side effect degree database
51. Standard operating process display screen
52. Reason registration screen
52b. Review reason registration screen
53. Case final result input screen
54. Required specification registration screen
54b. Specification change registration screen
55. Task review necessity determination/reason display screen
55b. Review task/reason display screen

1. An operating support system for calculating the influence of each of a plurality of tasks configuring an operating process, on a case to be performed according to the operating process,
wherein the operating support system comprises:
a storage unit including a first database for storing the task, the presence/absence value indicating whether the task is omitted in the performed case, and the evaluation value indicating the subsequent evaluation of the past case in association with the past case, as well as a second database for storing the specifications required for the past case, in association with the past case; and
a control unit,
wherein the control unit includes the steps of:
accepting the specifications required for the new case;
searching the second database based on the accepted specifications to obtain past cases which are similar to the extent that the specifications meet predetermined standards;
extracting the record of the obtained case from the first database;
determining the coefficient by which the presence/absence value is multiplied for the extracted record, as the side effect degree;
calculating the optimized side effect degree for each task with respect to the obtained case, by calculating the sum of the values obtained by multiplying the presence/absence value by the side effect degree for each task of the extracted record, and by calculating the difference between the calculated sum and the evaluation value; and
comparing the magnitude relationship between the calculated side effect degree and a predetermined threshold to output the task corresponding to the side effect degree identified based on the comparison, as the task that can be omitted in the new case.

2. An operating support system for calculating the influence of each of a plurality of tasks configuring an operating process, on a case to be performed according to the operating process,
wherein the operating support system comprises:
a storage unit including a first database for storing the task, the presence/absence value indicating whether the task has been reviewed in the performed case, and the evaluation value which is the value indicating the subsequent evaluation of the past case in association with the past case, as well as a second database for storing the specification item of the past case, the item value before change, and the item value after change, in association with the past case; and
a control unit,
wherein the control unit includes the steps of:
accepting the specification item of the past case, the item value before change, and the item value after change for the case;
searching the second database based on the accepted specification item, the item value before change, and the item value after change, to obtain past cases which are similar to the extent that the specification item, the item value before change, and the item value after change meet predetermined standards;
extracting the record of the obtained case from the first database;
determining the coefficient by which the presence/absence value is multiplied for the extracted record, as the base influence degree;
calculating the optimized side effect degree for each task with respect to the obtained case, by calculating the sum of the values obtained by multiplying the presence/absence value by the side effect degree for each task of the extracted record, and by calculating the difference between the calculated sum and the evaluation value;
calculating the reliability degree which becomes smaller as the calculated side effect degree increases; and
comparing the magnitude relationship between the calculated reliability degree and a predetermined threshold to output the task corresponding to the reliability degree identified based on the comparison, as the task to be reviewed in the case.

3. An operating support system according to claim 1,
wherein the first database stores the reason why each of the tasks is omitted or reviewed, in association with the presence/absence value indicating whether each of the tasks is omitted or reviewed,
wherein the control unit outputs the reason in association with the output task.

4. An operating support system according to claim 1,
wherein the control unit optimizes the side effect degree so as to minimize the sum of squares of the difference with respect to all the obtained cases.

5. An operating support method of an operating support system for calculating the influence of each of a plurality of tasks configuring an operating process, on a case to be performed according to the operating process,
wherein a storage unit of the operating support system stores a first database for storing the task, the presence/absence value indicating whether the task is omitted in the performed case, and the evaluation value which is the value indicating the subsequent evaluation of the past case in association with the past case, as well as a second database for storing the specifications required for the past case, in association with the past case,
wherein the control unit of the operating support system includes the steps of:
accepting the specifications required for the new case;
searching the second database based on the accepted specifications, to obtain past cases which are similar to the extent that the specifications meet predetermined standards;
extracting the record of the obtained case from the first database;
determining the coefficient by which the presence/absence value is multiplied for the extracted record, as the side effect degree;
calculating the optimized side effect degree for the obtained case, by calculating the sum of the values obtained by multiplying the presence/absence value by the side effect degree for each task of the extracted record, and by calculating the difference between the calculated sum and the evaluation value; and
comparing the magnitude relationship between the calculated side effect degree and a predetermined threshold to output the task corresponding to the side effect degree identified based on the comparison, as the task that can be omitted in the new case.

6. An operating support program that allows an operating support system to function to calculate the influence of each of a plurality of tasks configuring an operating process, on a case to be performed according to the operating process,
wherein the operating support program allows a storage unit of the operating support system to store a first database for storing the task, the presence/absence value indicating whether the task is omitted in the performed case, and the evaluation value which is the value indicating the subsequent evaluation of the past case in association with the past case, as well as a second database for storing the specifications required for the past case, in association with the past case,
wherein the operating support program allows a control unit of the operating support system to perform the steps of:
accepting the specifications required for the new case;
searching the second database based on the accepted specifications to obtain past cases which are similar to the extent that the specifications meet predetermined standards;
extracting the record of the obtained case from the first database;
determining the coefficient by which the presence/absence value is multiplied for the extracted record, as the side effect degree;
calculating the optimized side effect degree for each task with respect to the obtained case, by calculating the sum of the values obtained by multiplying the presence/absence value by the side effect degree for each task of the extracted record, and by calculating the difference between the calculated sum and the evaluation value; and
comparing the magnitude relationship between the calculated side effect degree and a predetermined threshold to output the task corresponding to the side effect degree identified based on the comparison, as the task that can be omitted in the new case.
